(19) United States
(12) Patent Application Publication
(10) Pub. No.: US 2001/0055645 A1
(43) Pub. Date: Dec. 27, 2001

(54) Caffeinated fruit juices

(76) Inventors: Laura A. Flook, Jersey City, NJ (US); Brian A. Williams, Jersey City, NJ (US)

Correspondence Address: KNOBLE & YOSHIDA, EIGHT PENN CENTER, SUITE 1350, 1628 JOHN F KENNEDY BLVD, PHILADELPHIA, PA, 19103, US

(21) Appl. No.: 09/788,003

(22) Filed: Feb. 16, 2001

Related U.S. Application Data
(60) Provisional application No. 60/182,963, filed on Feb. 16, 2000.

(51) Int. Cl. A23L 2/00

(52) U.S. Cl. 426/599; 426/73; 426/72

(57) ABSTRACT

A healthful caffeinated beverage that contains fruit juice and caffeine, preferably with a minimum of additional additives. Nutritional supplements such as vitamins and minerals may be added in small amounts, such as vitamins A, B, C, D and K, or minerals such as calcium, potassium or zinc. Preferably, the beverage contains at least 98 weight percent of fruit juice. This beverage will be beneficial for all consumers, and particularly for athletes and individuals with special medical needs who had been advised to restrict or eliminate soft drinks, coffees and teas from their diets due to the unhealthy ingredients or additives that are commonly found in those beverages.

§119(e) priority is hereby claimed based on U.S. Provisional Patent Application 60/182,963, filed Feb. 16, 2000.

### BACKGROUND OF THE INVENTION

1. Field of the Invention

This invention relates generally to an improved beverage that is both stimulating and healthful. More specifically, this invention relates to caffeinated fruit juices.

2. Description of the Related Technology

Caffeine is an alkaloid (C₈H₁₀O₂N₄.H₂O) that is found in coffee, tea, cacao, and some other plants. It is also present in most cola beverages. Caffeine has pharmacological effects on humans including increased blood pressure, stimulation of the central nervous system, promotion of urine formation, and stimulation of the heart and lungs. Caffeine is used in treating migraine because it constricts the dilated blood vessels and thereby reduces the pain. It also increases the potency of analgesics such as aspirin, and it can somewhat relieve asthma attacks by widening the bronchial airways. Caffeine is most commonly consumed to prevent and relieve fatigue, and to increase motor skills. It has even recently been advanced as a possible treatment for hyperactivity in children. In fact, some physicians are recommending that children who are suspected to have Attention Deficit Disorder or Attention Deficit Hyperactivity Disorder to drink a caffeinated beverage a few times each day in lieu of the commonly prescribed and abused medication Ritalin. Caffeine is produced commercially chiefly as a by-product in making caffeine-free coffee.

Many types of caffeinated beverages are commercially available, including a wide array of soft drinks, coffees, teas, and so forth. Many of these beverages, unfortunately, include ingredients in addition to caffeine that are unwanted by health-conscious consumers, which in many cases have been proven to be unnatural, harmful and unnecessary. Examples of such potentially harmful ingredients include acids such as acetic acid, malic acid, citric acid, phosphoric acid, fumaric acid and lactic acid. Acetic acid, for example, is a vinegar acid that is naturally present in dairy products, fruit and coffee. As an additive, this acid is used as an acidulant to aid in processing, a curing agent (for color stabilization or preservation) and a flavor enhancer. Unfortunately, laboratory tests have shown that it can cause cancer and rates in high doses, and, in concentrated form, it can act as an irritant to tissue and skin.

Artificial sweeteners Maltitol, Aspartame, Sorbitol and Saccharine are thought by many to be unhealthy. Sorbitol, for example, may in moderate amounts induce a harsh laxative effect and even cause diarrhea. Saccharine has been concluded in many studies to pose a risk of bladder cancer. Natural sweeteners such as high fructose corn syrup, glucose and dextrose provide no nutritional value, can promote tooth decay and typically break down very quickly, leading to extreme blood sugar fluctuations.

Artificial colorings such as caramel coloring, artificial flavoring as well as some types of natural flavorings have been hypothesized to have a causative relationship to attention deficit disorder, liver damage and even cancer.

Thickeners such as acacia gum, guar gum and starches may cause symptoms such as allergic reaction and/or intestinal disruption. Brominated vegetable oil, which is used as an emulsifier and clouding agent, may cause organ degeneration and central nervous system malfunction, and residual amounts of this substance may collect in body fat. As a result of this, the Food and Drug Administration has removed brominated vegetable oil from its list of substances that are generally recognized as safe. Glycerides, which are used as emulsifiers, crystallization inhibitors and preservatives are typically found in soft drinks and are handled by the body as fat. Glycerides may increase the calorie and cholesterol content of food and beverages.

Monosodium glutamate is an amino acid that helps protein production, and is often found in fruit juice. It can cause what is commonly referred to as “Chinese Restaurant Syndrome,” which is manifested by mood swings, rashes, itching, burning sensations, tightness in chest, breathing difficulties, asthma, depression, anxiety and headaches. It is known to be harmful to pregnant women and has been reported to destroy brain cells of infant lab animals.

Preservatives such as BHT are typically used in soft drinks, and have been reported to cause allergic reactions and, in one Japanese study, to cause cancer in laboratory animals.

Phosphates such as ammonium phosphate, calcium phosphate, tricalcium phosphate, potassium phosphate, sodium hexametaphosphate, sodium phosphate, dipotassium phosphate, trisodium phosphate, phosphoric acid and sodium pyrophosphate are typically used as texture risers, flavoring agents, alkali and has nutritional supplements in juice beverages. When consumed in high dosages, phosphates may be toxic and may contribute to osteoporosis and kidney malfunction or failure.

Other flavoring agents that are potentially harmful include quinine and the oil of bitter almond. Quinine is a flavoring additive that is used for bitter effect in soft drinks, and there is a possibility that it can cause birth defects when consumed by pregnant women. The oil of bitter almond contains about 85 percent benzaldehyde, which is part of the aldehyde family and is used as a reodorant in certain enbalming chemicals. Unfortunately, it has also been used in commercially distributed beverages.

Many consumers who would enjoy the stimulation provided by caffeine go without caffeine because of the perceived unhealthful nature of the caffeinated beverages that are presently available to them. A need exists for a more simple, healthy beverage that is caffeinated.

### SUMMARY OF THE INVENTION

Accordingly, it is an object of the invention to provide a more simple, healthy caffeinated beverage than those that have been heretofore known and used.

In order to achieve the above and other objects of the invention, a beverage according to a first aspect of the invention consists essentially of fruit juice; and caffeine.

A beverage that is formulated according to a second aspect of the invention includes fruit juice and caffeine with the beverage containing at least 98 weight percent of fruit juice.

These and various other advantages and features of novelty that characterize the invention are pointed out with particularity in the claims annexed hereto and forming a part hereof. However, for a better understanding of the invention, its advantages, and the objects obtained by its use, reference should be made to the accompanying descriptive matter, in which there is described a preferred embodiment of the invention.

### DETAILED DESCRIPTION OF THE PREFERRED EMBODIMENT(S)

A beverage according to the preferred embodiment of the invention preferably includes at least 98 weight percent fruit juice, with the balance of the beverage being pure caffeine, or a combination of caffeine and certain nutritionally active additives, such as vitamins and/or minerals. More preferably, the beverage includes at least 99 weight percent fruit juice, and less preferably the beverage includes at least 99.5 weight percent fruit juice. The fruit juice can be a single fruit juice or a combination of different fruit juices, and can be natural fruit juice or fruit juice that is reconstituted from concentrate. The fruit juice can be enhanced with additional fiber or pulp, which is considered to be part of the fruit juice for purposes of the weight percent described herein. The fruit juice can also be process to have reduced pulp or fiber, or to be pulp free.

Examples of nutritional supplements that may be added according to the invention include vitamins such as vitamin A, different types of B vitamins, vitamin C, vitamin D, and vitamin K. Among the B vitamins that might be added are Thiamin (B1), Riboflavin (B2), Pyridoxine (B6), Cobalmin (B12), Niacin, Folata and Biotin. Vitamins are preferably added in desired amounts that are within RDA standards.

The nutritional supplements may also include minerals such as calcium, potassium and zinc.

Aside from the nutritional supplements described above, one important aspect of the invention is that other potentially harmful ingredients that are common in many commercially distributed beverages such as soft drinks are avoided pursuant to the invention. These potentially harmful ingredients include all of the ingredients that are described with respect to the prior art beverages above, as well as additional ingredients that are not described but that are well known to have potentially harmful effects.

Different embodiments of beverages that are formulated according to the invention are described in the examples given below:

| Example | Fruit Juice (wt %) | Caffeine (wt %) | Other (wt %) |
|---|---|---|---|
| 1 | 99.93 | 0.07 | 0 |
| 2 | 99.86 | 0.14 | 0 |
| 3 | 99.79 | 0.21 | 0 |
| 4 | 99.72 | 0.28 | 0 |
| 5 | 99.65 | 0.35 | 0 |

Examples of different juices that are preferred for use in beverages formulated according to the invention include orange juice, tangerine juice, pineapple juice, grapefruit juice, lemonade, cranberry juice, grape juices, raspberry juice, and different combinations of two or more of these juices.

Caffeinated fruit juices according to the invention will provide stimulation to the central nervous system, allowing the consumer to feel more alert while providing a variety of vitamins, minerals and nutrients not obtained through consumption of other carbonated beverages, soda, coffee and tea. It will be a healthful and enjoyable alternative to the use of over-the-counter caffeine pills, which some consumers prefer over other caffeinated beverages that include ingredients that are less than healthful. It will permit consumers who may be too ill to tolerate harsh liquids like coffee, tea, soft drinks or energy drinks to enjoy the benefits of caffeine without additional digestive interruption, while providing those consumers nutrients that are lost and needed during illness, as well as hydration. Beverages according to the invention will be attractive to athletically inclined individuals and health-conscious individuals that wish to avoid unnecessarily potent carbohydrates and refined sugars that are common in other caffeinated beverages such as soft drinks. With the addition of extra minerals such as calcium to caffeinated fruit juice, the loss of calcium and bone density over time that has been attributed to extend the use of caffeine may be prevented or mitigated. Additionally, by reducing the amount of acid in caffeinated fruit juice, individuals suffering from internal ulcers and other similar disorders could still receive caffeine without excessive detriment to the visceral stomach lining that coffee, soft drinks and tea might incur. Individuals who smoke may find the invention to be an excellent alternative to vitamin supplements, particularly with regard to those embodiments of the invention that have additional vitamins and/or minerals. Since caffeine has been proven to enhance fatty acid metabolism, dieters in particular may find caffeinated fruit juice to be a healthy supplement to their dietary needs, while providing nutrients they may not receive on a restricted diet. Hospitals and rehabilitation centers might find serving caffeinated juice preferable to uncaffeinated juice, since caffeine can increase dopamine levels, possibly helping the patient feel better and enhancing the mental outlook that has been found beneficial to effective rehabilitation and recovery. Caffeine, being a catalyst for certain pharmacological reactions, might also lead hospitals to use caffeinated fruit juices in selected situations.

The invention will also be attractive to parents, who would certainly be expected to prefer their older children drinking caffeinated fruit juices as an alternative to soft drinks, coffee or tea.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A beverage consisting essentially of:
fruit juice; and
caffeine.

2. A beverage according to claim 1, further consisting essentially of at least one added nutritional supplement that is selected from the group consisting of vitamins and minerals.

3. A beverage according to claim 2, wherein said added nutritional supplement includes calcium.

4. A beverage according to claim 2, wherein said added nutritional supplement includes vitamin D.

5. A beverage according to claim 2, wherein said added nutritional supplement includes vitamin C.

6. A beverage according to claim 2, wherein said added nutritional supplement includes vitamin B.

7. A beverage according to claim 2, wherein said added nutritional supplement includes zinc.

8. A beverage according to claim 2, wherein said added nutritional supplement includes potassium.

9. A beverage according to claim 2, wherein said added nutritional supplement includes vitamin K.

10. A beverage according to claim 1, wherein said fruit juice is from concentrate.

11. A beverage according to claim 1, wherein said fruit juice has been processed to have a lower acidity than naturally occurring fruit juice of that type.

12. A beverage according to claim 1, wherein said fruit juice includes added pulp.

13. A beverage according to claim 1, wherein said fruit juice has been processed to have a lower amount of pulp than naturally occurring fruit juice of that type.

14. A beverage according to claim 13, wherein said fruit juice is substantially pulp free.

15. A beverage according to claim 1, wherein said beverage contains at least 98 weight percent fruit juice.

16. A beverage according to claim 15, wherein said beverage contains at least 99 weight percent fruit juice.

17. A beverage according to claim 16, wherein said beverage contains at least 99.5 weight percent fruit juice.

18. A beverage, comprising:
fruit juice; and
caffeine, and wherein said beverage contains at least 98 weight percent of said fruit juice.

19. A beverage according to claim 18, wherein said beverage contains at least 99 weight percent of said fruit juice.

20. A beverage according to claim 19, wherein said beverage contains at least 99.5 weight percent of said fruit juice.
